(19) United States
(12) Patent Application Publication
(10) Pub. No.: US 2023/0398567 A1
(43) Pub. Date: Dec. 14, 2023

(54) METHOD FOR IN-SITU APPLICATION OF AN INSULATING COMPOSITION

(71) Applicant: Joseph E. Pritchett, Shawnee, KS (US)

(72) Inventor: Joseph E. Pritchett, Shawnee, KS (US)

(21) Appl. No.: 18/209,836

(22) Filed: Jun. 14, 2023

Related U.S. Application Data
(62) Division of application No. 17/835,462, filed on Jun. 8, 2022, now abandoned.

(51) Int. Cl. B05D 1/02; C09D 133/08; C09D 5/08; C09D 163/00; C09D 7/20

(52) U.S. Cl. CPC B05D 1/02; C09D 133/08; C09D 5/08; C09D 163/00; C09D 7/20; B05D 2504/00; B05D 2502/00

(57) ABSTRACT

The method for in-situ application of an insulating composition can be used to restrict heat loss from industrial equipment such as pipes, boilers, heat exchangers, furnaces, tanks, fittings, and other facilities. The method includes spraying a water-based, ceramic-filled, acrylic composition onto external surfaces of operating equipment. Upon contact with the external surface, the composition crystalizes and bonds to pores in the external surface, forming salt spikes in a white solid film.

### CROSS-REFERENCE TO RELATED APPLICATION

This is a divisional application of U.S. patent application Ser. No. 17/835,462 filed Jun. 8, 2022, the contents of which are incorporated herein in their entirety by reference.

### BACKGROUND

### 1. Field

The disclosure of the present patent application relates to insulation and, particularly, to a method for in-situ application of an insulating composition.

### 2. Description of the Related Art

Many industrial processes require heating of fluids and/or other material to high temperatures ranging from, for example, 100° C. to temperatures exceeding 650° C. Industrial equipment such as pipes, tanks, furnaces, boilers, heat exchangers or other equipment that produce, store, and/or transport hot material are generally susceptible to heat loss through an exterior surface thereof.

Reduction of heat radiation from surfaces of the equipment can be important, for example, in the processing of crude oil. Crude oil is typically pumped through heat exchangers under high heat (300° C. to 500° C.) to breakdown crude into gasolines, solvents and refined chemicals. When heat generated during this process is lost through surfaces of the heat exchanger, the efficiency of crude oil production is minimized. By providing heat exchangers with adequate insulation, production of gasoline, solvents, and chemicals can be increased.

One current method of insulating external surfaces of equipment is through the use of reflective coatings. These coatings, however, are limited in their ability to provide adequate insulation, as reflectivity does not sufficiently retain heat within a hot surface. Another conventional method of insulating external surfaces of equipment includes applying wrap materials over the heated surfaces to “absorb” the heat emitted from the surface and slow the transfer of heat from the surface to the atmosphere. This process of slowing the loss of heat is insufficient to retain heat within the surface for long periods. For example, when the wrap material is fully heated by the transferred surface heat (known as “heat flux”), there is little to no resistance to slowing the heat loss.

Thus, a method for in-situ application of an insulation coating solving the aforementioned problems is desired.

### SUMMARY

A method for in-situ application of an insulating composition is useful for retaining heat within equipment containing a heated material. The equipment can include, for example, pipes, boilers, heat exchangers, furnaces, tanks, fittings, and other equipment or vessels typically used for heating a material, storing a heated material, or transporting a heated material. The method can include spraying an insulating composition on an external surface of the equipment while the equipment is in operation. Once the composition dries on the equipment external surface, an insulation coating is formed by the insulating composition that can block the transfer of heat from the equipment surface to the atmosphere. The insulating composition can be a water-based acrylic composition that includes ceramic compounds. Preferably, a temperature of the exterior surface of the equipment is at least 100° C. when the composition is sprayed thereon.

These and other features of the present subject matter will become readily apparent upon further review of the following specification.

### DETAILED DESCRIPTION OF THE PREFERRED EMBODIMENTS

A method for in-situ application of an insulating composition is useful for retaining heat within equipment. The term “equipment” should be understood to encompass any equipment or vessel that can emit heat while producing, storing, and/or transporting a hot or heated material. The heating equipment can include, for example, pipes, boilers, heat exchangers, furnaces, tanks, fittings, and other equipment typically used for heating fluids or other material. The heating equipment can be made from metal, for example. The method can include spraying an insulating composition on an external surface of the equipment. The insulating composition can be sprayed using a texture sprayer (also referred to as a “texture paint sprayer” or “texsprayer machine”). In an embodiment, the equipment is in operation while the composition is sprayed on the external surface thereof. In an embodiment, the equipment comprises underground equipment, such as underground piping, and the spraying is performed while the equipment is underground and in operation. In an embodiment, the underground piping is heated and pre-coated with the composition prior to underground installation. Once the composition dries on the equipment external surface, an insulation coating is formed that can block the transfer of heat from the equipment surface into the atmosphere. The insulating composition can be a water-based acrylic composition that includes a ceramic compound. Preferably, a temperature of the exterior surface of the equipment is at least 100° C. when the composition is sprayed thereon.

In an embodiment, the composition is sprayed onto the exterior surface of the equipment in stages. Initially, a thin layer of the composition can be sprayed onto the surface. Upon contact with the hot surface, steam is released. The composition crystalizes and bonds to the pores in the surface, thereby forming a white solid film including salt spikes. The initial thin layer of the composition allows steam to be released from the surface quickly, thereby avoiding the formation of bubbles that typically occurs with conventional coating methods. Subsequently, a plurality of layers of the insulating composition of equal or greater thickness can be applied over the initial layer until a desired thickness is achieved. Each layer can be allowed to dry before a subsequent layer is applied. Steam from the coating film can be released within about 30 seconds of application of each of the first few layers. By applying thinner coating layers initially, steam can be emitted from the surface quickly.

The resulting insulation formed by the plurality of coating layers can have strong adherence to the external surface of the equipment (“equipment external surface”) and can prevent or restrict heat from being transferred into the atmosphere through the exterior surface. It is believed that the insulation coating blocks rather than absorbs heat. Thus, the insulation coating differs from conventional insulation devices which simply slow the transfer of heat into the atmosphere by absorbing heat. Restricting heat loss in this manner increases heat efficiency inside the equipment. Heat loss calculations determined before and after applying the insulation coating demonstrated that heat loss from the exterior surface of the equipment can be reduced by as much as 86% by the insulation coating of the present teachings.

In an embodiment, one or more additional compositions may be applied on top of the insulation coating. Additional coating compositions can include, for example, a composition for repelling water (Moist Metal Grip®) or preventing moisture from penetrating into the insulation coating (Rust Grip®), and a composition for protecting the insulation coating from impact (SP Liquid Membrane™/SP Seal Coat HT)

The insulating composition can be a water-based, non-toxic coating system that can be easily and safely sprayed onto external equipment surfaces while in operation. Because the composition can be sprayed over an operating surface without shutdown of the equipment, the method is cost-effective and efficient. The composition can be a commercially available composition, such as HPC® or HPC®-HT, both of which are available from Superior Products International II, Inc. (10835 WE 78th Street, Shawnee, Kansas 66214). HPC® is an acrylic resin blend having specific ceramic compound loads, while HPC®-HT is a two-part hybrid silicone/acrylic water-based resin and other water-based resins, with specific ceramic compound loads. HPC® is generally used for exterior surface temperatures ranging from 100° C. to 232° C. The HPC®-HT is mixed with an additive on site before being applied to equipment. The HPC®-HT can be applied while the equipment is in operation and the exterior surface temperatures range from 232° C. to 650° C. The composition can include a combination of inert heat blocking ceramics loaded into an inorganic blended resin. The composition can facilitate blocking the loading and transfer of surface heat, thereby preventing or restricting energy loss and increasing the efficiency of the heating equipment by as much as 80%.

A thickness of the composition on the equipment surface can impact the amount of heat transferred from the equipment surface. Tables 1 and 2 show exemplary dry film thicknesses (dft) of HPC® and HPC®-HT, respectively, disposed on an equipment surface and the respective reduction of heat transfer achieved for each composition thickness. In an embodiment, the dft of HPC® on the equipment surface ranges from about 160 mils to about 880 mils. In an embodiment, the dft of HPC®-HT on the equipment surface ranges from about 1120 mils to about 2880.0 mils. As used herein, the term “about,” when used to modify a quantity, means within 10% of the modified quantity.

TABLE 1

| | | | | HPC ® Safe- | | HPC ® spread | |
|---|---|---|---|---|---|---|---|
| Max. | Max. | | | to-Touch | | rate for up to 8″ | |
| Temp. | Temp. | DFT of HPC ® | | temperature | | OD Pipe | |
| ° F. | ° C. | mm | mils | ° F. | ° C. | ft²/gal | m²/gal |
| 200 | 93.3 | 4.0 | 160.0 | 140 | 60.0 | 7.22 | 0.671 |
| 250 | 121.1 | 7.0 | 280.0 | 140 | 60.0 | 4.12 | 0.383 |
| 300 | 148.9 | 10 | 400.0 | 140 | 60.0 | 2.89 | 0.268 |
| 350 | 176.7 | 13.0 | 520.0 | 140 | 60.0 | 2.22 | 0.206 |
| 400 | 204.4 | 16.0 | 640.0 | 140 | 60.0 | 1.80 | 0.167 |
| 450 | 232.2 | 18.0 | 720.0 | 140 | 60.0 | 1.52 | 0.141 |
| 482 | 250 | 22.0 | 880.0 | 140 | 60.0 | 1.31 | 0.122 |

TABLE 2

| | | | | HPC ®HT | | | |
|---|---|---|---|---|---|---|---|
| | | | | surface | | HPC ®HT | |
| | | | | temperature | | spread rate for | |
| Max. | Max. | DFT of | | Safe-to- | | up to 8″ OD | |
| Temp. | Temp. | HPC ®HT | | Touch | | Pipe | |
| ° F. | ° C. | mm | mils | ° F. | ° C. | ft²/gal | m²/gal |
| 500 | 260 | 28 | 1120.0 | 140 | 60.0 | 1.174 | 0.109 |
| 550 | 288 | 31 | 1240 | 140 | 60.0 | 1.061 | 0.099 |
| 600 | 316 | 33 | 1320.0 | 140 | 60.0 | 0.996 | 0.093 |
| 650 | 343 | 35 | 1400.0 | 140 | 60.0 | 0.940 | 0.087 |
| 700 | 371 | 37 | 1480.0 | 140 | 60.0 | 0.889 | 0.083 |
| 750 | 399 | 43 | 1720.0 | 140 | 60.0 | 0.765 | 0.071 |
| 800 | 427 | 46 | 1840.0 | 140 | 60.0 | 0.715 | 0.066 |
| 850 | 454 | 50 | 2000.0 | 140 | 60.0 | 0.658 | 0.061 |
| 900 | 482 | 57 | 2280.0 | 140 | 60.0 | 0.577 | 0.054 |
| 950 | 510 | 60 | 2400.0 | 140 | 60.0 | 0.548 | 0.051 |
| 1000 | 538 | 65 | 2600.0 | 140 | 60.0 | 0.506 | 0.047 |
| 1100 | 593 | 70 | 2800.0 | 140 | 60.0 | 0.470 | 0.044 |
| 1112 | 600 | 72 | 2880.0 | 140 | 60.0 | 0.457 | 0.042 |

The present teachings are illustrated by the following examples.

### EXAMPLES

### Use of Insulating Composition on Hot Water Pipes

For applying the insulating composition on two identical glycol hot water pipes, each having a 4 inch diameter and a length of 275 feet, Hot Pipe Coating (HPC®) is used instead of conventional jacket insulation to provide insulation. HPC® provides corrosion-resistance, insulation, energy savings, and personal protection for temperatures up to 450° F. A two-part water repellant epoxy called Moist Metal Grip (MMG®) is used as a topcoat to seal the surface against moisture ingress.

For accelerated curing, HPC is applied directly on hot surfaces above 140° F.

To prepare the external surface of the equipment, loose, flaking paint is removed from the surface. A hand tool (SSPC SP 2) and a mechanical tool (SP 3) are used to prepare the external surface. CHLOR-RID salt/chloride remover or equivalent is used to remove salt via hydro power wash @ 3,500 psi. If a power wash is not possible, compressed air or mechanical wire wheel can be used to clean the external surface of the equipment after mechanical cleaning. Existing coatings should be free of any dirt, debris oil and residues.

After the external surface of the equipment is prepared as described above, HPC® is applied on the bare metal as directed by the manufacturer. An exemplary resulting coating on the metal includes the following:
1st Coat: (tex spray) HPC® (acrylic) @ 348 mils wet film thickness (WFT)/250 mils dry film thickness (DFT)—4.6 ft² per gallon;
2nd Coat: (tex spray) HPC® (acrylic) @ 348 mils wet film thickness (WFT)/250 mils dry film thickness (DFT)—4.6 ft² per gallon; and
3rd Coat: (spray/roll) Moist Metal Grip® (epoxy) @ 16 mils wet film thickness (WFT)/8 mils dry film thickness (DFT)—100 ft² per gallon (if water-proofing is needed).
Total System DFT: 516 mils/13.1 mm

Using a non-airless Graco® TexSpray GTX 2000 EX texture sprayer, two users spray 15 gallons of HPC® per hour. To accelerate cure times, each pipe is left online during application. HPC® is applied using the Graco® GTX 2000EX with spray gun using a 6 mm-8 mm nozzle. Each pail is mixed with a 6″ diameter dispersion blade at medium speed until a smooth texture is achieved. Successive coats are applied only when the moisture meter reads less than 5% moisture level for each coat.

Application of the composition on ambient surfaces is carried out as follows. On heated 4″ pipes and smaller, a tack coat is not necessary. Each coat of HPC® applied is 348 mils wet. A period of about 24-48 hours is allowed to elapse for the first coat to cure. Extra time is allotted for the 2nd coat of HPC® to dry out so that the surface moisture meter reads only 5% or less before applying the desired topcoat for weathering or water resistance. This is typically approximately 4-7 days later at ambient temperature or 2-3 days if original surface is left heated.

Thickness of subsequent coats is increased with multiple passes, while each pass is allowed to cure before re-applying HPC®. Alternatively, thickness of layers can be maintained at 348 mils wet for each coat, but more time is preferably allotted for curing.

For heated 6″ pipes which include HPC® layer thickness of 50 mils wet (1.27 mm), coating is allowed to steam off for a few minutes before applying additional product, e.g, approximately 5-10 minutes. Once steaming has stopped, 1st and 2nd coats are applied at 323 mils wet, with additional coats only being applied once steaming has stopped. A minimum of 24-48 hours of curing time is allowed between 1st and 2nd coats of HPC. The initial coat is allowed to dry until surface moisture meter tool reads only 5% or less before applying 2nd full coat of HPC.

The chosen top coating is sprayed using the designated tip with a fan width of 4″ (100 mm). For 21° C.+ (70° F.+) temperature, a minimum of 6-8 hour curing time is alotted before overcoating. For 10° C.+ (50° F.+) temperature, a minimum of 24 hours curing time is alotted before overcoating. Details of coating a 4″ inch pipe with HPC® and an 8″ inch pipe with HPC® are summarized in Tables 3 and 4 below, respectively.

TABLE 3
HPC ® on 4″ Pipe

| | | Total | Theoretical | Actual spread | |
|---|---|---|---|---|---|
| | | surface | spread rate per | rate per | HPC ® |
| Pipe size | Length | Area | gallon @ (500 | gallon @ (500 | gallons |
| (inch) | (ft) | (ft²) | mils DFT) | mils DFT) | required |
| 4 | 550 | 572 | 2.4 ft² | 2.16 ft² | 265 |

TABLE 4
HPC ® on 8″ Pipe

| | | Total | Theoretical | Actual spread | |
|---|---|---|---|---|---|
| | | surface | spread rate per | rate per | HPC ® |
| Pipe size | Length | Area | gallon @ (500 | gallon @ (500 | gallons |
| (inch) | (ft) | (ft²) | mils DFT) | mils DFT) | required |
| 8 | 550 | 1149.50 | 2.4 ft² | 2.16 ft² | 535 |

It is to be understood that the method for in-situ application of an insulating composition is not limited to the specific embodiments described above but encompasses any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. A method for in-situ application of an insulating composition, comprising the steps of:
a) operating an equipment, the operating of the equipment achieving an equipment external surface temperature ranging from about 100° C. to about 650° C.; and
b) spraying an initial amount of the insulating composition on the external surface of the equipment while the equipment is in operation to form an initial coating composition layer, the composition being a water-based composition including a ceramic compound;
c) allowing the initial coating composition layer to dry; and
d) spraying an additional amount of the insulating composition on the initial coating composition layer to form one or more additional coating composition layers on the external surface of the equipment, thereby providing an insulation coating on the external surface of the equipment.

2. The method for in-situ application of an insulating composition as recited in claim 1, wherein the insulating composition is HPC® and the equipment external surface temperature ranges from about 100° C. to about 232° C.

3. The method for in-situ application of an insulating composition as recited in claim 1, wherein the insulating composition is HPC®-HT and the equipment external surface temperature ranges from about 232° C. to about 650° C.

4. The method for in-situ application of an insulating composition as recited in claim 1, wherein the insulating composition is sprayed on the external surface of the equipment using a texture sprayer.

5. The method for in-situ application of an insulating composition as recited in claim 1, wherein spraying the insulating composition comprises forming first and second layers of insulating composition on the equipment.

6. The method for in-situ application of an insulating composition as recited in claim 5, wherein the first and second layers of insulating composition are of equal thickness.

7. The method for in-situ application of an insulating composition as recited in claim 6, wherein each of the first and second layers of insulating composition has a wet film thickness of 348 mils.

8. The method for in-situ application of an insulating composition as recited in claim 5, wherein the second layer of insulating composition has a greater thickness than the first layer of insulating composition.

9. A method for in-situ application of an insulating composition, comprising the steps of:
a) heating an equipment until an external surface of the equipment achieves a temperature ranging from about 100° C. to about 650° C.; and
b) spraying the insulating composition on the external surface of the equipment using a texture sprayer, the composition being selected from HPC® and HPC®-HT
c) allowing the coating composition to dry to provide an insulation coating on the external surface of the equipment.

10. The method for in-situ application of an insulating composition as recited in claim 9, wherein the insulating composition is HPC® and the equipment external surface temperature ranges from about 100° C. to about 232° C.

11. The method for in-situ application of an insulating composition as recited in claim 9, wherein the insulating composition is HPC®-HT and the equipment external surface temperature ranges from about 232° C. to about 650° C.

12. The method for in-situ application of an insulating composition as recited in claim 9, wherein spraying an insulating composition on the external surface of the equipment comprises spraying an initial coating composition layer on the equipment external surface and spraying one or more additional coating composition layers on the equipment once the initial layer dries.

13. The method for in-situ application of an insulating composition as recited in claim 9, wherein spraying the insulating composition comprises forming first and second layers of insulating composition on the equipment.

14. The method for in-situ application of an insulating composition as recited in claim 13, wherein the first and second layers of insulating composition are of equal thickness.

15. The method for in-situ application of an insulating composition as recited in claim 14, wherein the first and second layers of insulating composition has a wet film thickness of 348 mils.

16. The method for in-situ application of an insulating composition as recited in claim 13, wherein the second layer of insulating composition has a greater thickness than the first layer of insulating composition.

17. The method for in-situ application of an insulating composition as recited in claim 9, wherein the heating is achieved by operating the equipment and the insulating composition is sprayed while the equipment is in operation.

18. The method for in-situ application of an insulating composition as recited in claim 17, wherein spraying of the insulating composition occurs while the equipment is underground.

19. The method for in-situ application of an insulating composition as recited in claim 9, wherein the equipment is pre-heated and the spraying of the insulating composition occurs prior to installation underground.

20. The method for in-situ application of an insulating composition as recited in claim 19, wherein a dry film thickness of the insulation coating formed from HPC® ranges from about 160 mils to about 880 mils and a dry film thickness of the insulation coating formed from HPC®-HT ranges from about 1120 mils to about 2880.0 mils.
